(19) United States
(12) Patent Application Publication
(10) Pub. No.: US 2005/0231655 A1
(43) Pub. Date: Oct. 20, 2005

(54) Method and circuit for driving a liquid crystal display

(75) Inventors: Giuseppe Pasqualini, Monza (MI) (IT); Luigi Albani, Merate (IT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/522,288

(22) PCT Filed: Jul. 10, 2003
(86) PCT No.: PCT/IB03/03148

§ 371 Date: Jan. 25, 2005

(51) Int. Cl. G02F 1/133

(52) U.S. Cl. 349/36

(57) ABSTRACT

In a novel liquid crystal cell overdrive method, the actual voltage, on the liquid crystal cell (11), resulting the previous frame drive operation is measured, and the amount of the overdrive voltage is evaluated from this actually measured voltage. This method allows implementing the overdriving method without the use of a frame memory because it uses the intrinsic capacitance (CLC) of the liquid crystal cell (11) as a memory element. Moreover, this method allows a more accurate overdrive amount because its evaluation is based on the actual voltage present at the liquid crystal cell (11) resulting from the previous frame.

### FIELD OF THE INVENTION

The present invention relates in general to a method for driving liquid crystal pixels in a liquid crystal display.

### BACKGROUND OF THE INVENTION

Liquid crystal display panels are commonly known. With reference to FIG. 1, they comprise a matrix of liquid crystal display elements or pixels 10, one of which is illustrated in FIG. 1. Each pixel 10 comprises a liquid crystal cell 11, having one terminal connected to a common back electrode 12, common to a plurality of (usually all) pixels of the liquid crystal display panel, and having another terminal connected to a drain terminal of a pixel drive transistor 13.

The pixels are arranged according to a matrix of horizontal rows and vertical columns. All of the source electrodes of the drive transistors 13 in one column are connected to a common column electrode or data line 14. All data lines are coupled to corresponding outputs 21 of a data driver or column driver 20.

All of the gate electrodes of all drive transistors 13 in one row are connected to one common row electrode or gate line 15. All gate lines are connected to corresponding outputs 81 of a gate driver or row driver 80. The row driver 80 receives gate pulses PG from a gate pulse source 90, and provides these gate pulses consecutively to the gate lines in a predetermined order.

In operation, the rows of the display panel are driven successively by applying an appropriate gate pulse to only one of the gate lines at a time. This effectively constitutes a selection of one row of the matrix. As long as this row is selected (duration of gate pulse), the voltages at the data lines 14 as provided by the data driver 20 will determine the amount of light outputted from the corresponding pixel elements 10 in this specific row.

The row is maintained (driven) during a predetermined line time, as determined by the length of the above-mentioned gate pulse applied to the gate line 15. Subsequently, the next row is selected, and so on, until all rows in the matrix have been selected, after which the sequence continues from the first row in the matrix. All rows together define one image frame; the time necessary for driving all successive rows such as to display one complete frame will be indicated as the frame period.

Liquid crystal display panels suffer from problems such as motion blur and kickback. “Motion blur” is the phenomenon of a displayed object becoming blurred to a certain extent when this object is moved across the screen. This phenomenon is due to several causes, including the intrinsic low LC response time and the fact that the pixel capacitance depends on the voltage applied to the cell. “Kickback” is the phenomenon of an undesirable voltage drop occurring across the cell when the gate pulse is removed. This phenomenon is essentially due to parasitic elements present in the Liquid Crystal cell, and its magnitude (in terms of voltage drop) is not constant but depends on the capacity of the cell, which in turn is related to the voltage applied to the cell itself.

These problems are known per se, and correction methods have already been proposed to overcome or at least reduce these problems. All of these methods are based on the principle that it is possible to reduce the above-described phenomena by “overdriving” the cell. In such a known “overdriving” correction method, the data source signal V_{DS} as provided by the data source 20 is not applied to the data line 14 directly, but a correction value V_{corr} is added, such that the data drive voltage V_{d} applied to a data line 14 can be written as
V_{d}=V_{DS}+V_{corr}

The correction value V_{corr} depends, on the one hand, on the current data source signal V_{DS} as currently provided by the data source 20 and, on the other hand, on the data source signal V_{DS} provided by the data source 20 on the same data line with respect to the same pixel in the previous frame. Thus, for each pixel 10, the correction value V_{corr}(n) in an n-th frame can be written as a function of V_{DS}(n) and V_{DS}(n-1) in accordance with the following formula
V_{corr}(n)=f(V_{DS}(n); V_{DS}(n-1))

The data drive signal V_{d}(n) to be applied to this pixel 10 during the current n-th frame can thus be expressed by the following formula

$$\begin{matrix}{V}_{d} ( n ) = {V}_{DS} ( n ) + {V}_{corr} ( n ) = \\ = {V}_{DS} ( n ) + f ( {V}_{DS} ( n ) ; {V}_{DS} ( n - 1 ) )\end{matrix}$$

In the above formulas, the function f is a predetermined function of the two variables V_{DS}(n) and V_{DS}(n-1). The function f may be expressed as an analytical function, or as a table, or in any other suitable manner. The function f may depend on specific characteristics of the individual liquid crystal display, as will be clear to a person skilled in the art. In any case, the concept of using such a correction function f is known per se, and, as such, is not the subject of the present invention. Therefore, a more detailed explanation of this function is omitted here.

In the prior art, in order to determine the correction value V_{corr}, a frame memory 30 is used to store the pixel source signals V_{DS}(n-1) of the previous frame, as functionally illustrated in FIG. 1. A frame memory needs to have a memory capacity corresponding to the number of pixels in the liquid crystal display, and is relatively expensive.

Furthermore, in the prior art, the correction procedure is executed on the basis of a column driver signal V_{DS}(n-1), which is only an estimation of the data drive voltage actually presented to the liquid crystal cell 11 at the previous frame.

It is noted that FIG. 1 illustrates the correction procedure as if it were performed after the column driver; in practice the correction procedure is executed directly in the digital domain, on the data provided to the column driver, as will be clear to a person skilled in the art.

### SUMMARY OF THE INVENTION

It is an object of the present invention to provide a method and driver circuit for driving liquid crystal pixels, wherein the same functionality (i.e.: the overdriving method) of the state of the art can be achieved without having to use a frame memory. It is a further object of the present invention to provide a method and driver circuit for driving liquid crystal pixels, wherein the overdriving method is performed on the basis of measurement, instead of estimation (as in the prior art), of the voltage actually presented to the liquid crystal cell 11 at the previous frame. This allows a more accurate evaluation of the correction value V_{corr}(n).

The invention is defined by independent claims. The dependent claims define advantageous embodiments.

In order to achieve the above-mentioned objects, the present invention uses the intrinsic capacitance C_{LC} of each liquid crystal cell 11 as a pixel memory. In this way, an additional frame memory is no longer necessary, while furthermore the residual voltage remaining in said intrinsic capacitance C_{LC} after the previous frame is measured for calculating the correction value V_{corr}(n).

The invention is defined by the independent claims. The dependent claims define advantageous embodiments.

Accordingly, according to an important aspect of the present invention, a method for driving a liquid crystal cell comprises the steps of firstly measuring the voltage level remaining in the cell, and secondly driving the cell with a corrected drive signal on the basis of a data source signal V_{DS}(n) from a data source, on the one hand, and the measured cell voltage V_{d}(n-1), on the other hand.

Furthermore, a liquid crystal display driver circuit according to the present invention comprises sense means for sensing a cell voltage V_{d}(n-1), drive voltage generating means for generating a data drive signal V_{d}(n) on the basis of a current data source signal V_{DS}(n) supplied by a data source, on the one hand, and the measured cell voltage V_{d}(n-1), on the other hand, drive signal application means for applying the thus generated data drive signal V_{d}(n) to the liquid crystal cell, and control means for controlling the timing of the sense means and the drive signal application means.

### BRIEF DESCPRIPTION OF THE DRAWINGS

These and other aspects, features and advantages of the present invention will be further explained in the following description of a preferred embodiment of an LCD display driver according to the present invention with reference to the drawings, in which identical reference numerals indicate the same or similar parts, and in which:

FIG. 1 schematically illustrates a prior-art driver circuit;

FIG. 2 schematically illustrates a liquid crystal display driver circuit according to the present invention;

FIG. 3 is a graph illustrating the timing of drive pulses in an embodiment of a liquid crystal display driver circuit according to the present invention; and

FIG. 4 schematically illustrates an embodiment of a switch controller.

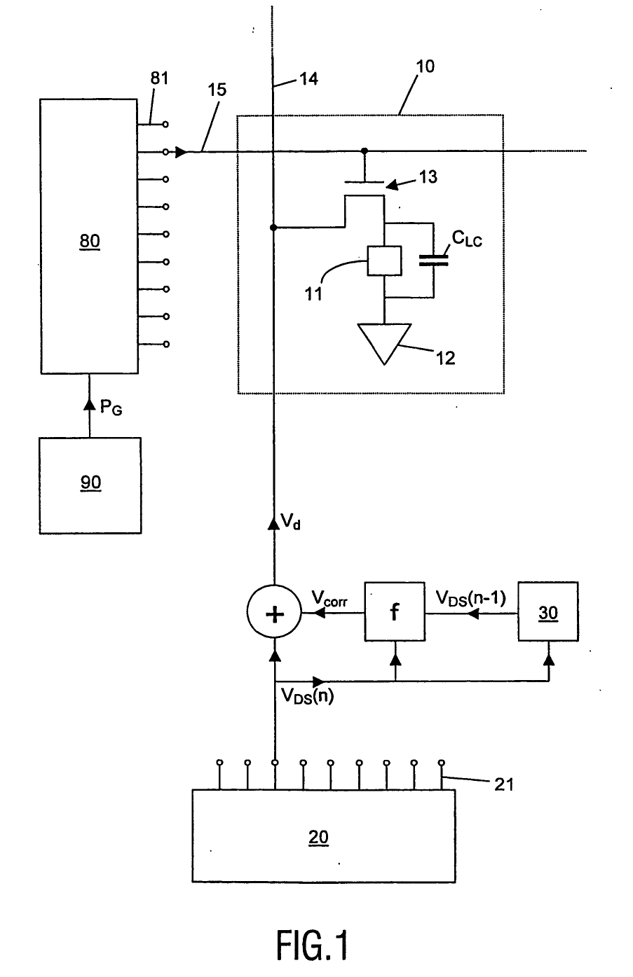

### DESCRIPTION OF PREFERRED EMBODIMENTS

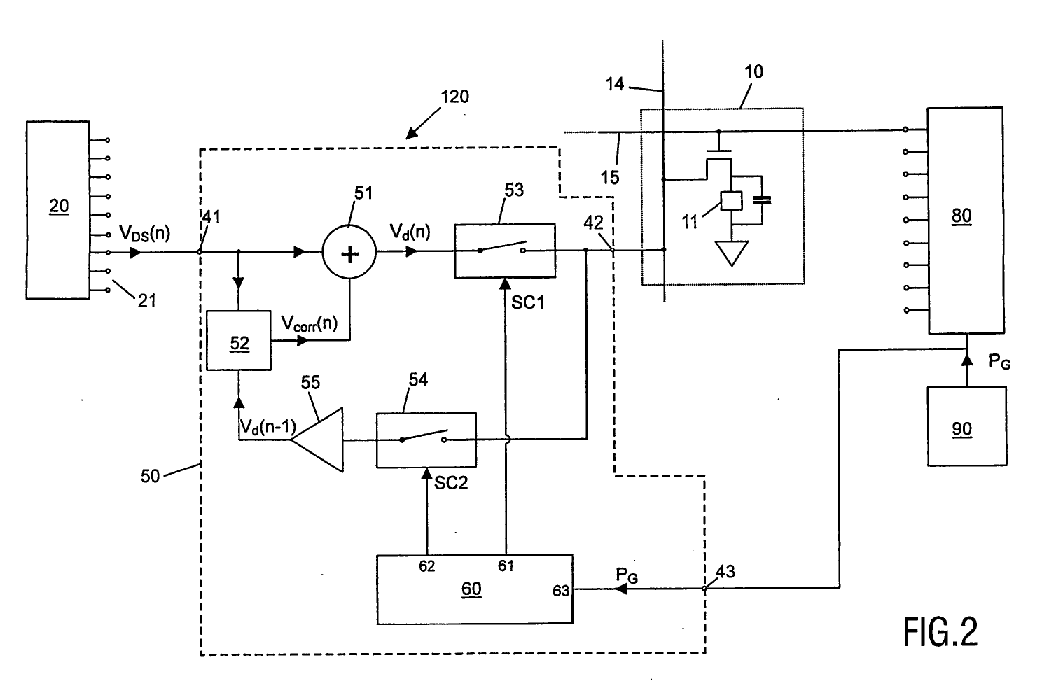

FIG. 2 schematically illustrates a circuit 50 for implementing the present invention for one data line 14, i.e. for one pixel 10 in a row. It will, however, be understood that, in a display device, a plurality of circuits 50 as illustrated in FIG. 2 will be provided, one for each data line.

The circuit 50 has a data signal input 41, a gate signal input 43, and an output 42. The data signal input 41 is coupled to an output 21 of the data source 20, providing the current data source signal V_{DS}(n). The output 42 is coupled to the data line 14.

In the circuit implementation of FIG. 2, the data signal input 41 is coupled to a first input of an adder 51 and to a first input of a function calculator unit 52. An output of the function calculator unit 52 is coupled to another input of said adder 51, the output of which is coupled to a first switch terminal of a first controllable switch 53. A second switch terminal of said first controllable switch 53 is coupled to a data line 14. The first controllable switch 53 has two operative states: in a first operative state, the switch 53 is conductive between two terminals, whereas in a second operative state, the switch 53 is non-conductive between two terminals. Preferably, and as shown, the switch 53 is implemented as a MOSFET. The first operative state will hereinafter be indicated as CLOSED and the second operative state will be indicated as OPEN. Selecting one of said two operative states, or switching, takes place under the control of a first switch control signal SC1 received at a control terminal.

A second controllable switch 54, preferably a MOSFET, has one terminal also connected to said data line 14, and has another switch terminal connected to an input of a latch 55, an output of which is connected to a second input of said function calculator unit 52. Similarly as the first controllable switch 53, the second controllable switch 54 has a first operative state CLOSED and a second operative state OPEN, switching taking place under the control of a second switch control signal SC2 received at a control terminal.

A switch controller 60 has two outputs 61, 62 providing the respective switch control signals SC1, SC2 for said two controllable switches 53, 54. The switch controller 60 has an input 63 coupled to the gate signal input 43 to receive the gate pulses P_{G} from the gate pulse source 90. The gate pulses are also supplied to gate driver 80. An output of the gate driver 80 is connected to the corresponding gate line 15.

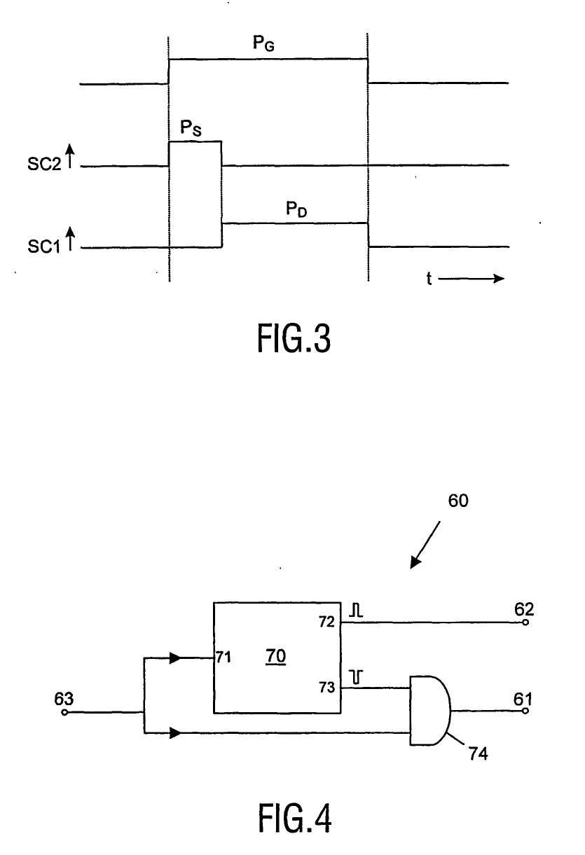

The switch controller 60 is adapted to generate switch control signals SC1, SC2 on the basis of the gate signals received at its input 63, as follows. When a gate pulse P_{G} is received, the switch controller 60 first generates at its second output 62 a sense pulse P_{S} as the second control signal SC2, having a duration of less than the gate pulse P_{G}. Then, after the sense pulse P_{S} has ended, the switch controller 60 generates at its first output 61 a drive pulse P_{D} as the first control signal SC1, the drive pulse P_{D} starting substantially when the sense pulse P_{S} ends and ending substantially when the gate pulse P_{G} ends. Preferably, there is a brief time period between the end of the sense pulse P_{S} and start of the drive pulse P_{D} in order to avoid an overlap between said two pulses. The timing of said three signals is illustrated in FIG. 3, showing the gate pulse P_{G}, the second control signal SC2 and the first control signal SC1, respectively, as a function of time t.

FIG. 4 shows a possible implementation of the switch controller 60, in an example where presence of a pulse corresponds to a logical HIGH and absence of a pulse corresponds to a logical LOW. A monopulse generator 70 is adapted to generate one pulse having a predetermined duration of less than a predetermined duration of the gate pulse PG, which is known in advance. The pulse generator 70 has a first output 72 which is normally LOW and provides a HIGH pulse. The pulse generator 70 further has a second output 73 which is normally HIGH and provides a LOW pulse, coupled to a first input of an AND gate 74. Thus, the second output signal at the second output 73 of the pulse generator 70 is the inverted signal with respect to the first output signal at its first output 72. Therefore, alternatively, the first output 72 of the pulse generator 70 can be coupled to said first input of said AND gate 74 through an inverter.

The pulse generator 70 is adapted to generate its pulses when a positive edge is received at a trigger input 71 of the pulse generator 70. This trigger input 71 is coupled to said input 63 of the switch controller 60 so as to receive the gate signal P_{G}. Also, a second input of said AND gate 94 is coupled to said input 63 of the switch controller 60 so as to receive the gate signal P_{G}. The first output 72 of the pulse generator 70 is coupled to said second output 62 of the switch controller 60, and the output of the AND gate 74 is coupled to the first output 61 of the switch controller 60.

In operation, the output of the AND gate 74 is initially LOW, because the gate signal P_{G} is initially LOW. When a gate pulse P_{G} is received, more specifically when the leading edge of the gate pulse P_{G} is received, the pulse generator 70 will generate at its first output 72 a HIGH pulse, which will be provided as sense pulse P_{S} at the second output 62 of the switch controller 60. During this sense pulse P_{S}, the output of the AND gate 74 will remain LOW. Then, when the pulse generated by the pulse generator 70 has ended, the output of the AND gate 74 will be HIGH during the remainder of the duration of the gate pulse P_{G}, and this will be supplied as output pulse, i.e. drive pulse P_{D}, at the first output 61 of the switch controller 60.

Thus, the addressing phase as determined by the length of the gate pulse P_{G} has effectively been divided into two parts by the switch controller 60, the two parts hereinafter being indicated as “sense phase” and “drive phase”. The length of the sense phase is determined by the length of the pulse generated by the pulse generator 70, whereas the length of the drive phase is determined by the length of the output pulse at the first output 61 of the switch controller 60, i.e. the difference of the lengths of the gate pulse PG and the sense pulse P_{S}. Typically, the duration of the sense phase will be less than the duration of the drive phase.

During the sense phase, the first controllable switch 53 is OPEN and the second controllable switch 54 is CLOSED under the control of the sense pulse P_{S}. Thus, the voltage remaining in the liquid crystal cell 11 is coupled to the input of the latch 55. The function calculating unit 52 now receives at its first input the current data source signal V_{DS}(n) of the current frame, and receives at its second input the residual cell voltage V_{d}(n-1) measured during the sense phase. On the basis of these two input signals, the function calculating unit 52 determines, in a manner known per se, the current correction signal V_{corr}(n), which is added to the current data source signal V_{DS}(n) to provide the current cell drive signal V_{d}(n). However, this current cell drive signal V_{d}(n) is not applied to the cell 11 during the sense phase, because during the sense phase the first controllable switch 53 is OPEN.

After the sense phase, during the drive phase, the second controllable switch 54 is OPEN and the first controllable switch is CLOSED under the control of the drive pulse P_{D}, so that the current cell drive signal V_{d}(n) is applied to the data line 14, and is thus applied to the liquid crystal cell 11 “selected” by the gate pulses P_{G}, without being disturbed by the presence of a sense circuit because the second controllable switch 54 is now OPEN. During the drive phase, the measured residual cell voltage V_{d}(n-1) will be “remembered” by virtue of the latch 55.

It is noted that the exact operation of the function calculating unit 52 is not essential to the present invention. In this respect, it is recalled that, in prior-art devices, function calculating units are known which receive at their second input a signal which is indicative of the previous cell drive signal V_{DS}(n-1) of the previous frame as an estimation of the current residual cell voltage, this signal being provided by a frame memory. In practising the present invention, starting from a prior art device, the memory function of such a frame memory may be replaced by the memory function of the cell capacitance giving a more accurate value, as described above. The function calculating unit could be any type of calculating unit, for instance a suitably programmed hardware calculating device that could be implemented in an analog and/or digital way, programmed to calculate an output function value on the basis of two input values.

It should be clear to a person skilled in the art that the present invention is not limited to the exemples of embodiments discussed above, but that various variations and modifications are possible within the protective scope of the invention as defined in the appended claims.

For instance, although the liquid crystal display driver circuit 50 is described as being a unit separate from the data source or column driver 20, it is also possible that the liquid crystal display driver circuit 50 is implemented as an integral part of the data source or column driver 20. The combination of data source 20 and liquid crystal display driver circuit 50 will hereinafter also be indicated as “integrated data source 120”. In that case, the gate signal input 43 may be an input of integrated data source 120; the output 21 and data signal input 41 will be an internal node of such an integrated data source 120, and output 42 will be an output of such an integrated data source 120.

Furthermore, an embodiment is described above where the sense means provide a sense means output signal substantially equal to the remaining cell voltage as measured. However, although this is preferred, this is not necessary. Alternatively, it is possible, for instance, that the sense means provide a sense means output signal which differs from the actual cell voltage by a predetermined factor, while the calculating means may be designed to take such a factor into account when calculating the correction value. This is expressed as a sense means output signal representing the remaining cell voltage.

It is also possible to combine the calculator unit 52 and the adder 51 in an alternative calculator unit using an alternative function f to calculate directly V_{d}(n) from V_{DS}(n) and V_{d}(n-1).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. Use of the verb “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method for driving a liquid crystal cell, comprising the steps of:
receiving a data source signal from a data source;
measuring a residual voltage level remaining in this cell from a previous frame;
calculating a drive signal as a function of said data source signal and said residual voltage level; and
applying the drive signal to said cell.

2. A liquid crystal display driver circuit, comprising:
sense means for sensing a cell voltage of a liquid crystal cell and providing a sense means output signal representing said cell voltage;
drive voltage generating means for generating a data drive signal on the basis of a data source signal, on the one hand, and said sense means output signal, on the other hand;
drive signal application means for applying the thus generated data drive signal to the liquid crystal cell; and
a switch controller for controlling the timing of the sense means and the drive signal application means.

3. A liquid crystal display driver circuit according to claim 2, comprising:
a data signal input for coupling to an output of a data source;
a gate signal input for coupling to a gate pulse source;
a circuit output for coupling to a data line of a liquid crystal display;
the drive voltage generating means having a first input coupled to the data signal input;
said drive signal application means being coupled between an output of the drive voltage generating means and said circuit output;
said sense means being coupled between a second input of said drive voltage generating means and said circuit output.

4. A liquid crystal display driver circuit according to claim 3, wherein said sense means comprise a latch having an output coupled to said second input of said drive voltage generating means.

5. A liquid crystal display driver circuit according to claim 3, wherein said drive signal application means comprise a first controllable switch having a control input coupled to a first output of the switch controller;
wherein said sense means comprise a second controllable switch having a control input coupled to a second output of said controller;
wherein said switch controller has an input coupled to the gate signal input.

6. A liquid crystal display driver circuit according to claim 5, wherein said switch controller is adapted, when receiving a gate pulse at its input, to generate at its second output a sense pulse as the second control signal for the second controllable switch, such that the second controllable switch is switched to a conductive state for the duration of said sense pulse, wherein the sense pulse has a predetermined duration which is shorter than the duration of a gate pulse; and
to generate, after said sense pulse, a drive pulse as the first control signal for the first controllable switch, such that the first controllable switch is switched to a conductive state for the duration of said drive pulse, wherein the duration of said drive pulse substantially corresponds to the duration of the gate pulse minus the predetermined duration.

7. A liquid crystal display driver circuit according to claim 6, wherein said switch controller comprises:
a monopulse generator triggerable by leading edges of gate pulses, adapted to generate at a first output output pulses having the predetermined duration, said first output being coupled to said second output of said switch controller;
an AND gate having one input coupled to said input of said switch controller, and having another input coupled to receive inverted output pulses from the monopulse generator, an output of the AND gate being coupled to said first output of said switch controller.

8. A liquid crystal display driver circuit according to claim 2, wherein the drive voltage generating means comprise:
a function calculation unit, for receiving the data source signal and the sense means output signal,
an adder for adding the data source signal to a correction signal, being an output of the function calculation unit; and
an output of the adder, being the output of the drive voltage generating means.

9. A liquid crystal display, comprising a matrix of pixels arranged in rows and columns, each pixel comprising a liquid crystal cell having one terminal connected to a drain electrode of a driver transistor, a source electrode of the driver transistor being connected to a column data line and a gate electrode of the driver transistor being connected to a row gate line;
each row gate line being coupled to a corresponding output of a gate driver;
each column data line being associated with a liquid crystal display driver circuit according to claim 2, each column data line being coupled to the output of the associated driver circuit, the data input of this associated driver circuit being coupled to a corresponding output of a data driver.

10. An integrated data source, comprising:
a data source having an output for providing a data source signal; and
a liquid crystal display driver circuit according to claim 2.
